(19) United States
(12) Patent Application Publication
(10) Pub. No.: US 2021/0118303 A1
(43) Pub. Date: Apr. 22, 2021

(54) METHOD OF CONTROLLING VEHICLE CONSIDERING ADJACENT PEDESTRIAN'S BEHAVIOR

(71) Applicant: LG ELECTRONICS INC., Seoul (KR)

(72) Inventor: Jaegal CHAN, Seoul (KR)

(73) Assignee: LG ELECTRONICS INC., Seoul (KR)

(21) Appl. No.: 16/740,941

(22) Filed: Jan. 13, 2020

(30) Foreign Application Priority Data
Oct. 18, 2019 (KR) 10-2019-0130083

(51) Int. Cl. G08G 1/16; B60Q 5/00; B60Q 1/52; G08G 1/005; G08G 1/01

(52) U.S. Cl. CPC G08G 1/166; B60Q 5/006; G08G 1/167; G08G 1/005; G08G 1/0112; B60Q 1/525

(57) ABSTRACT

The present invention relates to methods of predicting risk of collision depending on the behavior of a pedestrian adjacent to a driving vehicle and controlling the vehicle for preventing collision. According to an embodiment of the present invention, a method of controlling a vehicle comprises identifying a pedestrian adjacent to a driving road of the vehicle, determining a first recognition value of the pedestrian for the vehicle based on a behavior feature of the pedestrian, outputting a warning signal based on the first recognition value, determining a second recognition value of the pedestrian after outputting the warning signal, and controlling the vehicle based on the second recognition value.

### CROSS-REFERENCE TO RELATED APPLICATION

Pursuant to 35 U.S.C. § 119(a), this application claims the benefit of earlier filing date and right of priority to Korean Patent Application No. 10-2019-0130083, filed on Oct. 18, 2019, the contents of which are all hereby incorporated by reference herein in its entirety.

### BACKGROUND

### 1. Field of the Invention

The present invention relates to methods of predicting risk of collision depending on the behavior of a pedestrian adjacent to a driving vehicle and controlling the vehicle for preventing collision.

### 2. Description of Related Art

There are ongoing efforts to make autonomous vehicles (AVs) commercially available. According to technology recently under development, an AV recognizes other vehicles around on the road via various sensors equipped therein.

As such, an AV is armed with various sensors, such as ultrasonic sensors, infrared (IR) sensors, radio detecting and ranging (RADAR), light detection and ranging (LiDAR), or camera sensors and identifies nearby obstacles via the sensors.

Some algorithms under development for AVs allow an AV to selectively recognize pedestrians among its surrounding obstacles and to drive considering the position of the identified pedestrians.

In controlling driving of an AV, the conventional algorithms consider pedestrian's position alone but not pedestrians' behavior and thus fail to properly respond, e.g., when they are far away from the vehicle although there is the likelihood of collision and hence injury due to distracted walking, such as looking at their cell phones or wearing a headset while walking.

Further, if a pedestrian is positioned close to the vehicle so she perceives the vehicle, e.g., when she tries to hail a cab, these algorithms cause the vehicle to slow down or drive around the pedestrian albeit it is not necessary.

Therefore, a need exists for a method of controlling vehicles considering pedestrians' behaviors as well as their positions.

### SUMMARY OF THE INVENTION

An object of the present invention is to control a vehicle depending on the behaviors of pedestrians near the vehicle.

Another object of the present invention is to output different warning signals depending on the behaviors of pedestrians near the vehicle.

Still another object of the present invention is to determine the efficiency of a warning signal and thus update the priority of the warning signal.

The present invention is not limited to the foregoing objectives, but other objects and advantages will be readily appreciated and apparent from the following detailed description of embodiments of the present invention. It will also be appreciated that the objects and advantages of the present invention may be achieved by the means shown in the claims and combinations thereof.

To achieve the foregoing objects, according to an embodiment of the present invention, a method of controlling a vehicle comprises identifying a pedestrian adjacent to a driving road of the vehicle, determining a first recognition value of the pedestrian for the vehicle based on a behavior feature of the pedestrian, outputting a warning signal based on the first recognition value, determining a second recognition value of the pedestrian after outputting the warning signal, and controlling the vehicle based on the second recognition value.

The present invention may control a vehicle depending on the behavior of a pedestrian adjacent to the vehicle in such a manner that vehicle control is selectively performed only on pedestrians who are actually put at risk of collision, thereby enabling efficient vehicle driving while ensuring pedestrians' safety.

The present invention may output different warning signals depending on the behaviors of the pedestrian adjacent to the vehicle and thus allow the pedestrian to easily recognize the vehicle regardless of what behavior the pedestrian is taking, thereby preventing the pedestrian from collisions.

The present invention may determine the efficiency of warning signals and accordingly update the priorities of the warning signals, advantageously alerting the pedestrian of danger in the most efficient way.

The foregoing or other specific effects of the present invention are described below in conjunction with the following detailed description of the present invention.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flowchart illustrating a method of controlling a vehicle according to an embodiment of the present invention;

FIG. 2 is a view illustrating the position relationship between a vehicle, a server, and a pedestrian according to an embodiment of the present invention;

FIG. 3 is a view illustrating an internal configuration of a vehicle as shown in FIG. 2;

FIG. 4 is a view illustrating the process of identifying a nearby pedestrian;

FIGS. 5 and 6 are views illustrating a method of setting recognition values depending on a pedestrian's walking direction;

FIG. 7 is a view illustrating a method of setting recognition values depending on a pedestrian's viewing direction;

FIG. 8 is a view illustrating a method of setting recognition values depending on a pedestrian's pattern and walking pattern;

FIG. 9 is a table illustrating a method of updating the priority of a warning signal;

FIG. 10 is a view briefly illustrating a data communication process between a server and a vehicle as shown in FIG. 2;

FIG. 11 is a view illustrating an example process of application communication between a vehicle and a server in a 5G communication system; and

FIGS. 12, 13, 14, and 15 are views illustrating example operations of a vehicle using 5G communication.

### DETAILED DESCRIPTION OF EXEMPLARY EMBODIMENTS

The foregoing objectives, features, and advantages are described below in detail with reference to the accompanying drawings so that the technical spirit of the present invention may easily be achieved by one of ordinary skill in the art to which the invention pertains. When determined to make the subject matter of the present invention unclear, the detailed description of the known art or functions may be skipped. Hereinafter, preferred embodiments of the present invention are described in detail with reference to the accompanying drawings. The same reference denotations are used to refer to the same or similar elements throughout the drawings.

Although the terms “first” and “second” are used to describe various components, the components are not limited by the terms. These terms are used simply to distinguish one component from another, and a first component may be a second component unless stated otherwise.

As used herein, when a component is disposed “on (or under)” or “on the top (or bottom) of” another, the component may be disposed directly on (or under) the other component, or any other component(s) may intervene between the component and the other component.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

As used herein, the singular forms “a,” “an,” and “the” are intended to include the plural forms as well, unless the context clearly indicates otherwise. As used herein, the term “comprise,” “include,” or “have” should be appreciated not to preclude the presence or addability of features, numbers, steps, operations, components, parts, or combinations thereof as set forth herein.

As used herein, the phrase “A and/or B” may mean “A, B” or “A and B” unless stated otherwise, and the phrase “C to D” may mean “not less than C and not more than D” unless stated otherwise.

The present invention relates to methods of predicting risk of collision depending on the behavior of a pedestrian adjacent to a driving vehicle and controlling the vehicle for preventing collision.

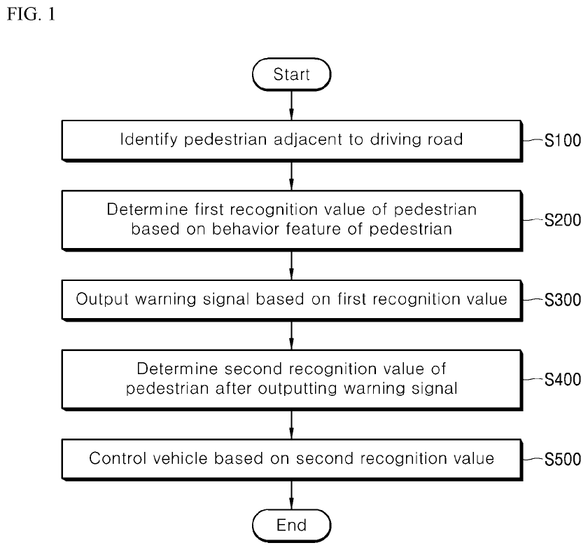

A method of controlling a vehicle is described below with reference to FIGS. 1 to 9 according to an embodiment.

FIG. 1 is a flowchart illustrating a method of controlling a vehicle according to an embodiment of the present invention.

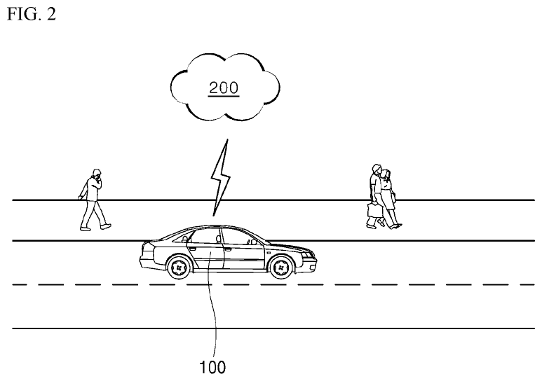

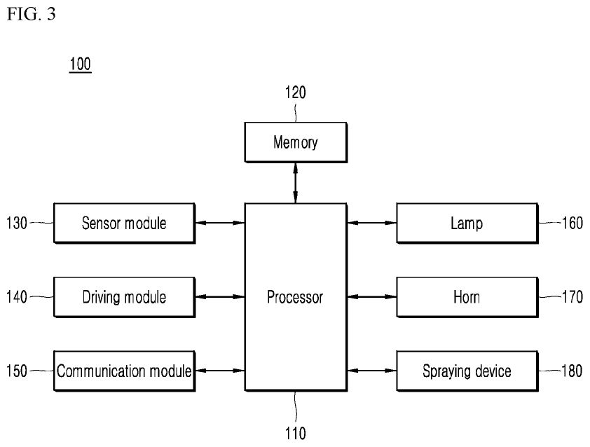

FIG. 2 is a view illustrating the position relationship between a vehicle, a server, and a pedestrian according to an embodiment of the present invention. FIG. 3 is a view illustrating an internal configuration of a vehicle as shown in FIG. 2.

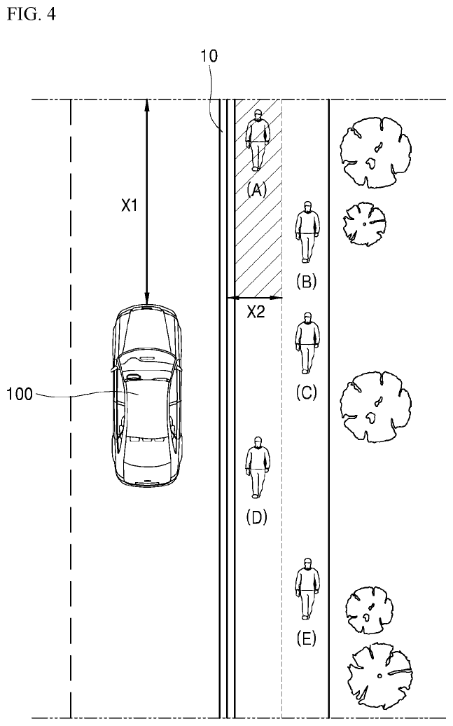

FIG. 4 is a view illustrating the process of identifying a nearby pedestrian.

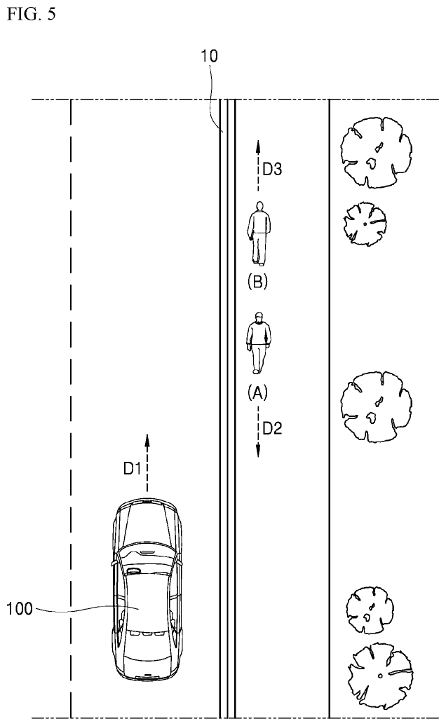

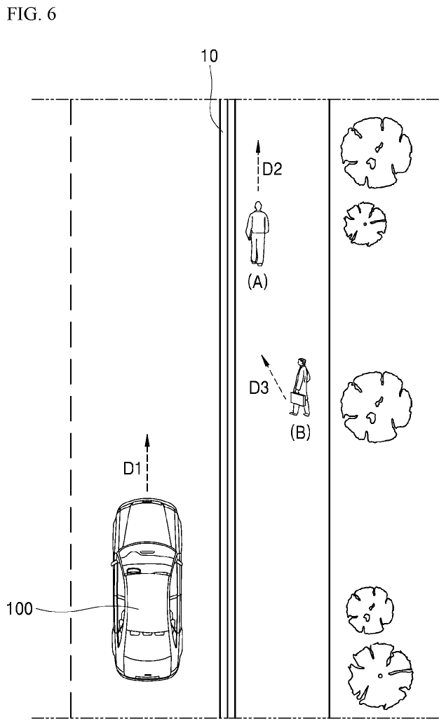

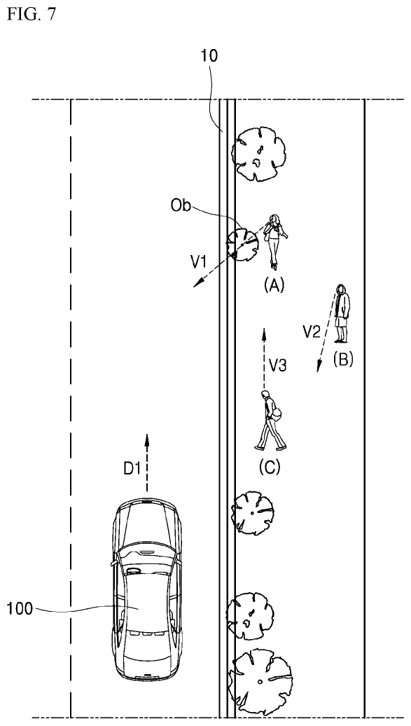

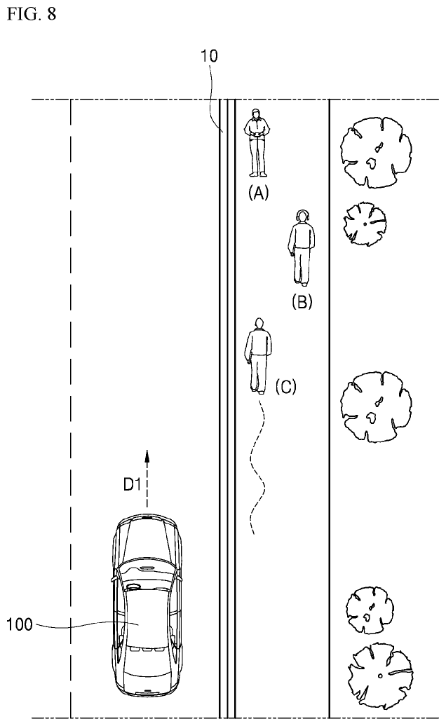

FIGS. 5 and 6 are views illustrating a method of setting recognition values depending on a pedestrian's walking direction. FIG. 7 is a view illustrating a method of setting recognition values depending on a pedestrian's viewing direction. FIG. 8 is a view illustrating a method of setting recognition values depending on a pedestrian's pattern and walking pattern.

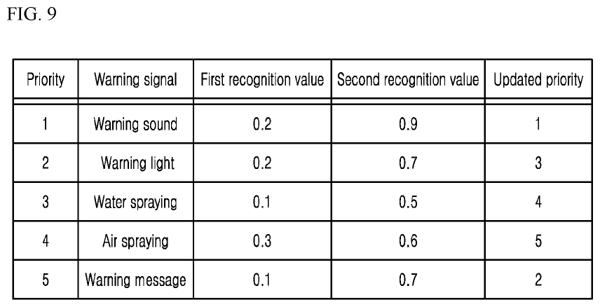

FIG. 9 is a table illustrating a method of updating the priority of a warning signal.

Referring to FIG. 1, according to an embodiment, a method of controlling a vehicle may include the steps of identifying a pedestrian adjacent to a driving road (S100), determining a first recognition value of the pedestrian based on the pedestrian's behavior feature (S200), outputting a warning signal based on the first recognition value (S300), determining the pedestrian's second recognition value after outputting the warning signal (S400), and controlling the vehicle based on the second recognition value (S500).

The vehicle control method shown in FIG. 1 is merely an example and the present invention is not limited to the steps of FIG. 1 but may rather add more steps or some of the steps may be modified or deleted as necessary.

The vehicle control method of FIG. 1 may be performed by a vehicle 100 or a server 200. Specifically, the vehicle control method may be performed by a processor equipped in the vehicle 100 or the server 200, and the processor may be implemented as a physical element including at least one of application specific integrated circuits (ASICs), digital signal processors (DSPs), digital signal processing devices (DSPDs), programmable logic devices (PLDs), or field programmable gate arrays (FPGAs).

Referring to FIG. 2, the vehicle 100 may drive on a road, and a pedestrian may be walking near the road. Where the vehicle control method is performed by an internal processor of the server 200, the vehicle 100 may perform wireless data communication with the server 200, which is described below.

The vehicle 100 may be a driver-operated vehicle or a self-driving vehicle capable of automatically driving without the driver's intervention. The vehicle 100 may be implemented as, e.g., an internal combustion engine vehicle, which adopts an engine as its power source, a hybrid vehicle, which adopts an engine and an electric motor as its power source, an electric vehicle, which adopts an electric motor as its power source, and a fuel cell electric vehicle, which adopts fuel cells as its power source.

The vehicle 100 to which embodiments of the disclosure apply may be associated with any artificial intelligence (AI) modules, drones, unmanned aerial vehicles, robots, augmented reality (AR) modules, virtual reality (VR) modules, or 5th generation (5G) mobile communication devices.

Each step of FIG. 1 is described below in detail under the assumption that the vehicle control method is performed by the processor 110 in the vehicle 100.

Referring to FIG. 3, according to an embodiment of the present invention, the vehicle 100 may include a processor 110, a memory 120, a sensor module 130, a driving module 140, a communication module 150, a lamp 160, a horn 170, and a spraying device 180. The vehicle 100 shown in FIG. 3 is merely an example and the components thereof are not limited to those shown in FIG. 1 but may rather add more components or some of the components may be modified or deleted as necessary.

The sensor module 130 may identify the pedestrian near the driving road of the vehicle 100 (S100). The driving road of the vehicle 100 may be defined as a road on which the vehicle 100 is driving.

The sensor module 130 may be implemented as various devices for identifying the pedestrian. For example, the sensor module 130 may be a camera sensor that captures a visible image and process the captured image to identify the pedestrian or may be a laser sensor that emits a laser beam and detect the laser beam to identify the pedestrian.

Where the sensor module 130 is a laser sensor, the sensor module 130 may be implemented as a RADAR that emits and detects microwaves or as a LiDAR that emits and detects light (e.g., laser pulses).

The sensor module 130, however, is not limited thereto but may be implemented as any device capable of identifying the pedestrian near the vehicle 100.

Where the sensor module 130 is a camera sensor, the sensor module 130 may be installed on the outer surface of the vehicle 100 to capture the external image of the vehicle 100 and identify the pedestrian in the captured external image as an object. Where the sensor module 130 is a laser sensor, the sensor module 130 may be installed on the outer surface of the vehicle 100 and may emit a laser beam to the outside of the vehicle 100, detect the reflected laser beam to thereby identify obstacles, and identify the pedestrian among the identified obstacles.

To that end, the sensor module 130 may perform object detection, which is performed by such techniques as frame differencing, optical flow, or background subtraction, and object classification, which is performed by such techniques as shape-based classification, motion-based classification, color-based classification, or texture-based classification. To track the pedestrian detected as an object, the processor 110 may perform object tracking, which is performed by such techniques as point tracking, kernel tracking, or silhouette.

Besides, the sensor module 130 may use various image processing algorithms and object recognition algorithms to detect the pedestrian.

The sensor module 130 may identify the pedestrian positioned within a reference distance of the driving lane 10. The driving lane 10 may be any one of the lanes of the driving road. Specifically, the driving lane 10 may be defined as a lane adjacent to the sidewalk among the lanes of the driving road.

The sensor module 130 may further include a lane sensor provided on the bottom of the vehicle 100. The lane sensor may sense a lane via, e.g., visible light or infrared (IR) light and calculate the position of the detected lane.

The sensor module 130 may identify a plurality of pedestrians adjacent to the driving road by the above-described method and identify only pedestrians within the reference distance of the position of the lane among the plurality of pedestrians.

Where the vehicle 100 drives on a road with no driving lane 10, the processor 110 may generate a virtual lane based on the full width of the vehicle 100, and the sensor module 130 may identify the pedestrian positioned within the reference distance of the position of the virtual lane.

Specifically, the processor 110 may determine the positions of both side ends of the vehicle 100 by referring to the full width of the vehicle 100 stored in the memory 120 and determine that the position resulting from adding a predetermined width to both side ends of the vehicle 100 is the position of the virtual lane, thereby generating the virtual lane. Then, the processor 110 may provide information regarding the position of the virtual lane to the sensor module 130, and the sensor module 130 may identify the pedestrian positioned within the reference distance of the position of the virtual lane.

Although a method of generating a virtual lane is described as an example, generation of a virtual lane may be performed by various methods available in the art.

The reference distance used for the sensor module 130 to identify the pedestrian may be set in proportion to the speed of the vehicle 100.

The vehicle 100 may move further away as the speed increases although controlled during the same time. For example, when the vehicle 100 comes to a sudden stop in an emergency, the moving distance of the vehicle 100 may be prolonged as the speed of the vehicle 100 increases.

Thus, in identifying the pedestrian positioned within the reference distance of the driving lane 10 and likely to be hit by the vehicle 100, the reference distance may be set to be proportional to the speed of the vehicle 100.

On the other hand, pedestrians who the vehicle 100 has already passed or are positioned far away from the road may have no chance of being hit by the vehicle 100. Thus, the sensor module 130 may identify only pedestrians who are positioned within a second reference distance X2 of a side of the driving lane 10 among a plurality of pedestrians positioned within a first reference distance X1 of the front of the vehicle 100.

Referring to FIG. 4, there may be pedestrians A, B, C, D, and E walking on the sidewalk adjacent to the driving road. The processor 110 may determine the position of the front of the vehicle 100 by referring to the full length of the vehicle 100 from the memory 120 and provide information regarding the position of the front of the vehicle 100 to the sensor module 130.

The sensor module 130 may identify pedestrians A, B, and C positioned within the first reference distance X1 in front of the position of the front of the vehicle 100 among pedestrians A to E. Subsequently, the sensor module 130 may identify pedestrian A as the pedestrian positioned within the second reference distance X2 to the side from the position of the driving lane 10 among pedestrians A to C.

In other words, the sensor module 130 may identify at least one pedestrian who is most likely to be physically hit by the vehicle 100 among the plurality of pedestrians.

If the pedestrian is identified by the above-described method, the sensor module 130 may further identify the behavior feature of the pedestrian, and the processor 110 may determine a first recognition value of the pedestrian for the vehicle 100 based on the pedestrian's behavior feature (S200).

The behavior feature of the pedestrian may be a characteristic, property, or feature defined regarding, e.g., posture, movement, behavior, or action. The first recognition value may be defined as a value regarding the likelihood to recognize the vehicle 100, and as the first recognition value increases, the likelihood to recognize the vehicle 100 may rise.

In other words, the processor 110 may determine the value regarding the likelihood for the pedestrian to recognize the vehicle 100 based on, e.g., the posture, movement, behavior, or action of the pedestrian identified by the sensor module 130.

In a first example, the sensor module 130 may identify the pedestrian's walking direction, and the processor 110 may determine the first recognition value based on the walking direction.

The likelihood for the pedestrian to recognize the vehicle 100 may vary depending on the relationship between the pedestrian's walking direction and the driving direction of the vehicle 100. For example, where the vehicle approaches from the direction in which the pedestrian views while walking, the likelihood for the pedestrian to recognize the vehicle 100 may be high. In contrast, if the vehicle approaches from behind the walking pedestrian, the likelihood for the pedestrian to recognize the vehicle 100 may be low.

The sensor module 130 may detect a variation in the position of the pedestrian to thereby determine the walking direction of the pedestrian, and the processor 110 may determine the pedestrian's first recognition value based on the walking direction.

Specifically, if the pedestrian's walking direction is opposite to the driving direction of the vehicle 100, the processor 110 may determine that the first recognition value is larger than a reference value and, if the pedestrian's walking direction is identical to the driving direction of the vehicle 100, determine that the first recognition value is smaller than the reference value.

It is assumed below that the first recognition value is determined to range from 0 to 1 and that the reference value is set to 0.5.

Referring to FIG. 5, the sensor module 130 may identify pedestrians A and B as adjacent to the driving road, and the sensor module 130 may determine that the walking direction of pedestrian A is D2 and the walking direction of pedestrian B is D3 based on variations in the position of pedestrians A and B.

Since the walking direction D2 of pedestrian A is opposite to the driving direction D1 of the vehicle 100, the processor 110 may determine that the first recognition value of pedestrian A is larger than 0.5. In contrast, since the walking direction D3 of pedestrian B is identical to the driving direction D1 of the vehicle 100, the processor 110 may determine that the first recognition value of pedestrian B is smaller than 0.5.

The processor 110 may determine the first recognition value proportional to the angle between the pedestrian's walking direction and the driving direction of the vehicle 100.

Referring to FIG. 6, the sensor module 130 may identify pedestrians A and B as adjacent to the driving road and determine that the walking direction of pedestrian A is D2 and the walking direction of pedestrian B is D3 based on the viewing direction of pedestrian A.

The processor 110 may determine the first recognition value within a range from 0 to 1 in proportion to the angle between the pedestrian's walking direction and the driving direction of the vehicle 100. In other words, where the angle between the pedestrian's walking direction and the driving direction of the vehicle 100 ranges from 0 degrees to 180 degrees, the processor 110 may determine that the pedestrian's first recognition value is in a range from 0 to 1 to linearly correspond to the angle.

Specifically, the angle between the walking direction D2 of pedestrian A and the driving direction D1 of the vehicle 100 may be 0 degrees in FIG. 6. Thus, the processor 110 may determine that the first recognition value of pedestrian A is the minimum value, e.g., 0. The angle between the walking direction D3 of pedestrian B and the driving direction D1 of the vehicle 100 may be 40 degrees. Thus, the processor 110 may determine that the first recognition value of pedestrian B is 0.222 linearly corresponding to 40 degrees.

In a second example, the sensor module 130 may identify the pedestrian's viewing direction, and the processor 110 may determine the first recognition value based on the viewing direction.

The likelihood for the pedestrian to recognize the vehicle 100 may vary depending on the relationship between the pedestrian's viewing direction and the driving direction of the vehicle 100. For example, where the vehicle approaches from the direction in which the pedestrian views, the likelihood for the pedestrian to recognize the vehicle 100 may be high. In contrast, where the vehicle approaches from a direction out of the direction in which the pedestrian views, the likelihood for the pedestrian to recognize the vehicle 100 may be low.

The sensor module 130 may detect the direction in which the pedestrian views, thereby determining the pedestrian's viewing direction. The processor 110 may determine the first recognition value of the pedestrian based on the viewing direction.

The method of determining the first recognition value depending on the viewing direction may be identical to the above-described method of determining the first recognition value depending on the walking direction. Now described is a process in which the processor 110 determines the first recognition value proportional to the angle between the pedestrian's viewing direction and the driving direction of the vehicle 100.

Referring to FIG. 7, the sensor module 130 may identify pedestrians A, B, and C as adjacent to the driving road, and the sensor module 130 may determine that the viewing direction of pedestrian A is V1, the viewing direction of pedestrian B is V2, and the viewing direction of pedestrian C is V3 based on the viewing directions of pedestrians A, B, and C.

The angle between the viewing direction V1 of pedestrian A and the driving direction D1 of the vehicle 100 may be 140 degrees. Thus, the processor 110 may determine that the first recognition value of pedestrian A is 0.778 linearly corresponding to 140 degrees.

The angle between the viewing direction V2 of pedestrian B and the driving direction D1 of the vehicle 100 may be 165 degrees. Thus, the processor 110 may determine that the first recognition value of pedestrian B is 0.917 linearly corresponding to 165 degrees.

The angle between the viewing direction V3 of pedestrian C and the driving direction D1 of the vehicle 100 may be 0 degrees. Thus, the processor 110 may determine that the first recognition value of pedestrian C is the minimum value, e.g., 0.

Meanwhile, the sensor module 130 may identify an obstacle between the pedestrian and the vehicle 100, and the processor 110 may determine the first recognition value depending on whether the obstacle between the pedestrian and the vehicle 100 is positioned in the pedestrian's viewing direction.

Referring back to FIG. 7, the sensor module 130 may identify the obstacle Ob between pedestrian A and the vehicle 100 and calculate the position of the obstacle Ob. The processor 110 may determine whether the obstacle Ob is positioned in the viewing direction V1 of pedestrian A. Specifically, the processor 110 may determine whether a virtual line indicating the viewing direction V1 of pedestrian A crosses the obstacle Ob.

Upon determining that the obstacle Ob is positioned in the viewing direction V1 of pedestrian A, the processor 110 may set the first recognition value of pedestrian A to be smaller than the reference value. In contrast, upon determining that the obstacle Ob is not positioned in the viewing direction V1 of pedestrian A, the processor 110 may set the first recognition value of pedestrian A to be larger than the reference value.

Alternatively, the processor 110 may correct the first recognition value depending on whether the obstacle is positioned in the pedestrian's viewing direction.

In the example described above in connection with FIG. 7, the first recognition value of pedestrian A may be determined to be 0.778 according to the viewing direction V1 of pedestrian A. At this time, if the obstacle Ob is positioned in the viewing direction V1 of pedestrian A, the processor 110 may determine that the final first recognition value of pedestrian A is 0.389 by multiplying the first recognition value of pedestrian A by a correction value (e.g., 0.5).

In a third example, the sensor module 130 may identify the pedestrian's behavior, and the processor 110 may determine the first recognition value based on the pedestrian's behavior.

The likelihood for the pedestrian to recognize the vehicle 100 may vary depending on what the pedestrian is currently doing. For example, although the pedestrian's viewing direction is opposite to the driving direction of the vehicle 100, if the pedestrian is looking straight at her cell phone, the pedestrian may be less likely to recognize the vehicle 100. As another example, although the pedestrian's viewing direction is identical to the driving direction of the vehicle 100, if the pedestrian tries to hail a cab, the pedestrian may be highly likely to recognize the vehicle 100.

The sensor module 130 may detect the pedestrian's behavior and identify the pedestrian's behavior, and the processor 110 may determine the first recognition value based on the pedestrian's behavior.

Specifically, the processor 110 may determine the first recognition value corresponding to the pedestrian's behavior by referring to the memory 120. To that end, the memory 120 may previously store recognition values corresponding to the pedestrian's various behaviors.

Referring to FIG. 8, the sensor module 130 may identify that pedestrian B adjacent to the driving road is wearing a headset. The memory 120 may previously store 0.2 which is a recognition value corresponding to the behavior of wearing a headset, and the processor 110 may determine that the first recognition value of pedestrian B is 0.2 by referring to the memory 120.

The processor 110 may also correct the first recognition value depending on the pedestrian's behavior.

Referring back to FIG. 8, the sensor module 130 may identify pedestrian A adjacent to the driving road, and the processor 110 may determine that the first recognition value of pedestrian A is 1 depending on the walking direction of pedestrian A. Subsequently, the sensor module 130 may identify that pedestrian A is using a cell phone. The memory 120 may previously store a recognition correction value, e.g., 0.6, corresponding to the behavior of using a cell phone, and the processor 110 may determine that the first recognition value of pedestrian A is 0.6 which is a result of multiplying the first recognition value, 1, by 0.6, by referring to the memory 120.

Although the pedestrian's behavior of wearing a headset or using a cell phone has been described above as an example, the pedestrian's other various behaviors may be identified, and the processor 110 may determine the pedestrian's first recognition value depending on the identified behaviors.

In a fourth example, the sensor module 130 may identify the pedestrian's walking pattern, and the processor 110 may determine the first recognition value depending on the pedestrian's walking pattern.

The likelihood for the pedestrian to recognize the vehicle 100 may vary depending on the pedestrian's body conditions. For example, where the pedestrian is drunken, is walking distracted, or is handicapped, the pedestrian's walking pattern may be inconstant and, in such a case, the pedestrian may have difficulty in recognizing the vehicle 100 or, although recognizing the vehicle 100, it may be hard for the pedestrian to respond to any emergency.

The sensor module 130 may identify the pedestrian's walking pattern via a variation in the pedestrian's position, and the processor 110 may determine the first recognition value based on the pedestrian's walking pattern.

Referring back to FIG. 8, the sensor module 130 may detect a variation in the position of pedestrian C adjacent to the driving road, thereby identifying the walking pattern of pedestrian C. The processor 110 may calculate the degree of regularity of pedestrian C based on the walking pattern according to the variation in the position of pedestrian C. The degree of regularity is a parameter indicating the degree as to how regular the walking pattern is. The more regular the walking pattern is, the higher degree of regularity may be obtained.

The processor 110 may determine the first recognition value in proportion to the degree of regularity of the walking pattern. Specifically, the processor 110 may determine the first recognition value to linearly correspond to the degree of regularity of the walking pattern.

In a fifth example, the sensor module 130 may detect the pedestrian's behavior feature, and the processor 110 may determine the pedestrian's age based on the detected behavior feature and determine the first recognition value based on the age.

The likelihood for the pedestrian to recognize the vehicle 100 may vary depending on the pedestrian's age. For example, where the pedestrian is an old person or toddler, the pedestrian may have difficulty in recognizing the vehicle 100 or, although recognizing the vehicle 100, it may be hard for the pedestrian to respond to any emergency.

The sensor module 130 may detect the pedestrian's behavior feature, e.g., height or posture, and the processor 110 may determine the pedestrian's age via the detected behavior feature.

For example, the sensor module 130 may identify a stooped pedestrian adjacent to the driving road, the processor 110 may determine that the pedestrian is an old person based thereupon. Further, the sensor module 130 may identify a pedestrian who is 130 cm tall and is positioned adjacent to the driving road, the processor 110 may determine that the pedestrian is a kid based thereupon.

The processor 110 may determine the first recognition value corresponding to the pedestrian's age by referring to the memory 120. To that end, the memory 120 may previously store recognition values per pedestrian age. For example, the processor 110 may determine that the first recognition value is 0.8 for elderly pedestrians and children and 0.5 for the other pedestrians.

Although in the above-described example, the pedestrians are limited to elderly people or children, embodiments of the present invention are not limited thereto. For example, the processor 110 may determine the first recognition value for each of a plurality of age groups.

Two or more of the above-described methods of determining the first recognition value according to the first to fifth examples may be combined and performed. When two or more of the above-described methods are combined and performed, it is obvious that the first recognition value may be corrected by a determining reference for each method.

If the first recognition value is determined, the vehicle 100 may output a warning signal (S300). Specifically, the processor 110 may control an output device, e.g., the communication module 150, the lamp 160, the horn 170, or the spraying device 180, to output a warning signal.

The warning signal may be a signal for warning of the risk of collision and may be output as warning light, a warning sound, visible signal, or audible signal. The warning signal may also be output in an electronic form, such as a warning message, or may be output as a physical signal, e.g., sprayed air or water. Examples of outputting such warning signals are described below.

As set forth above, since the first recognition value is a parameter indicating the likelihood for the pedestrian to recognize the vehicle 100, the processor 110 may control the output device to output a warning signal when the first recognition value is low. Specifically, the processor 110 may compare the first recognition value with a warning reference value stored in the memory 120 and, if the first recognition value is less than the warning reference value, output the warning signal.

In the second example described above in connection with FIG. 7, the respective first recognition values of pedestrians A, B, and C may be determined to be 0.778, 0.917, and 0, respectively. In this case, the processor 110 may compare the first recognition value of each pedestrian with the warning reference value, e.g., 0.4. As a result of comparison, since the first recognition value, 0, of pedestrian C is less than the warning reference value, 0.4, the processor 110 may control the output device to output the warning signal.

In other words, if the first recognition value of any one of the plurality of pedestrians is less than the warning reference value, the processor 110 may control the output device to output the warning signal.

Meanwhile, the processor 110 may control the output device to output warning light or warning sound, transmit a warning message to the pedestrian's terminal, or spray or jet air or water based on the above-described behavior feature of the pedestrian. In other words, the processor 110 may perform control to output the warning signal corresponding to the pedestrian's behavior feature identified via the sensor module 130 through the output module.

According to an embodiment, where the pedestrian's walking direction is identical to the driving direction of the vehicle 100 as for pedestrian A shown in FIG. 6, the vehicle 100 approaches from behind the back of the pedestrian and, thus, the pedestrian may be unable to recognize the vehicle 100 although the vehicle 100 turns on the warning light. In this case, the processor 110 may control the output device to output an audible signal. Specifically, the processor 110 may control the horn 170 to output a warning sound.

According to an embodiment, where the pedestrian's walking direction is opposite to the driving direction of the vehicle 100 as for pedestrian B shown in FIG. 6, the vehicle 100 faces the pedestrian and, thus, the processor 110 may control the output device to output a visible signal. Specifically, the processor 110 may control the lamp 160 to output warning light.

In another embodiment, where the pedestrian is using a cell phone capable of wireless data communication as is pedestrian A of FIG. 8, the processor 110 may allow a message to be output on the cell phone. Specifically, the processor 110 may control the communication module 150 to transmit a warning message to the pedestrian's cell phone. The warning message may be visibly output via the cell phone.

Where the pedestrian is wearing a headset capable of wireless data communication as is pedestrian B of FIG. 8, the processor 110 may allow a message to be output on the headset. Specifically, the processor 110 may control the communication module 150 to transmit a warning message to the pedestrian's headset. The warning message may be audibly output via the cell phone.

In still another embodiment, where the degree of regularity of the pedestrian's walking pattern is less than a reference value, e.g., as for pedestrian C of FIG. 8, the processor 110 may control the output device to output a physical signal. Specifically, the processor 110 may control the spraying device 180 to spray or jet air or water.

The above-described output of a warning signal may be performed on any one pedestrian who is most likely to be hit by the vehicle. More specifically, where there are a plurality of pedestrians for whom the first recognition value is less than the warning reference value, the processor 110 may control the output device to output a warning signal based on the behavior feature of any one pedestrian for whom the first recognition value is the lowest.

In the example described above in connection with FIG. 8, the respective first recognition values of pedestrians A, B, and C may be determined to be 0.6, 0.2, and 0.1, respectively. In this case, the processor 110 may mutually compare the respective first recognition values of the pedestrians and determine that any one pedestrian with the lowest first recognition value is pedestrian C. Subsequently, the processor 110 may determine that the degree of regularity of the walking pattern of pedestrian C is less than the reference value, and the processor 110 may control the spraying device 180 to jet air or water.

In contrast, where the respective first recognition values of pedestrians A, B, and C are determined to be 0.6, 0.2, and 0.3, respectively, the processor 110 may determine that any one pedestrian whose first recognition value is the lowest is pedestrian B. Since pedestrian B is wearing a headset, the processor 110 may control the communication module 150 to transmit a warning message of the headset of pedestrian B.

As set forth above, the present invention may output different warning signals depending on the behaviors of the pedestrian adjacent to the vehicle and thus allow the pedestrian to easily recognize the vehicle regardless of what behavior the pedestrian is taking, thereby preventing the pedestrian from collisions.

The processor 110 may output warning signals depending on a preset order of priority. Specifically, a priority may be preset on each warning signal and, under the same condition, only one warning signal which has the highest priority may be output.

Referring to FIG. 9, when the pedestrian's first recognition value is less than the warning reference value, the processor 110 may output a warning sound, warning message, water, or air via the output device. In this case, a priority may be preset on each warning signal, and the warning sound may have the highest priority. Thus, the processor 110 may control the horn 170 to output the warning sound.

If the pedestrian's recognition value is not varied although the warning sound is output, the processor 110 may control the lamp 160 to output the warning light which has the next highest priority. As such, the processor 110 may perform control to sequentially output the warning signals according to the priorities each of which have been set on a respective one of the warning signals.

After the warning signal is output, the processor 110 may determine the pedestrian's second recognition value (S400). The second recognition value may be the same in concept as the above-described first recognition value. The recognition value determined before the warning signal is output may be the first recognition value, and the recognition value determined after the warning signal is output may be the second recognition value. In other words, the second recognition value may be a recognition value determined based on the pedestrian's behavior feature which has been varied by the warning signal.

The sensor module 130 may identify the pedestrian's behavior feature depending on the warning signal, and the processor 110 may determine the pedestrian's second recognition value based on the behavior feature. The method of determining the second recognition value is the same as the above-described method of determining the first recognition value, and no detailed description thereof is given below.

The processor 110 may control the vehicle 100 based on the second recognition value (S500). In other words, the processor 110 may control the vehicle 100 depending on the pedestrian's behavior feature after the warning signal is output.

Typically, the vehicle 100 and the pedestrian may react to the warning signal output from the vehicle 100. For example, the pedestrian may turn the viewing direction to the vehicle 100 and turn the walking direction to the vehicle 100. The pedestrian may also make the walking pattern regular and take off the headset. Thus, the pedestrian's second recognition value determined after the warning signal is output may be high.

However, if the pedestrian does not react despite the warning signal, the likelihood of collision may further increase as the distance between the pedestrian and the vehicle 100 decreases.

Thus, if the second recognition value is less than a control reference value, the processor 110 may control the vehicle 100. The control reference value may be preset by the user. However, since controlling the vehicle 100 needs to be performed in a more limited context than the above-described context where the warning signal is output, the control reference value may be set to be not more than the above-described warning reference value.

If the second recognition value is less than the control reference value, the processor 110 may enable the driving module 140 to control each driving device (e.g., a power driving device, a steering device, a braking device, a suspension driving device, or a steering wheel driving device) in the vehicle 100.

In particular, if the second recognition value is less than the control reference value, the processor 110 may control the driving module 140 to reduce the speed of the vehicle 100. Meanwhile, where the vehicle 100 is an AV 100, the processor 110 may control the driving module 140 via an obstacle avoidance algorithm, allowing the vehicle 100 to drive around the pedestrian.

Regarding speed control, the processor 110 may control the speed of the vehicle 100 to be proportional to the second recognition value. In other words, the processor 110 may control the speed of the vehicle 100 to be lower as the second recognition value decreases and to be higher as the second recognition value increases.

For example, the processor 110 may control the speed based on the value resultant from multiplying the current speed of the vehicle 100 by the second recognition value. Specifically, where the current driving speed of the vehicle 100 is 60 km/h, and the second recognition value of the pedestrian who is likely to be hit by the vehicle 100 is 0.3, the processor 110 may control the driving module 140 to reduce the speed of the vehicle 100 up to 18(60×0.3)km/h.

As set forth, the present invention may control a vehicle depending on the behavior of a pedestrian adjacent to the vehicle in such a manner that vehicle control is selectively performed only on pedestrians who are actually put at risk of collision, thereby enabling efficient vehicle driving while ensuring pedestrians' safety.

The processor 110 may cumulatively store the first recognition value for each pedestrian and the second recognition value after the warning signal is output in the memory 120. Then, the processor 110 may calculate a difference between the first recognition value and the second recognition value and update the priority of the warning signal based on the calculated difference.

Specifically, the processor 110 may update the priority of each warning signal so that the priority increases as the difference between the first recognition value and the second recognition value increases.

Referring to FIG. 9, a priority may be preset on each warning signal. Whenever each warning signal is output, the processor 110 may store the first recognition value determined before the warning signal is output and the second recognition value determine after the warning signal is output in the memory 120.

For the warning sound which has the first priority, the difference between the first recognition value (e.g., 0.2) and the second recognition value (e.g., 0.9) may be 0.7. For the warning light which has the second priority, the difference between the first recognition value (e.g., 0.2) and the second recognition value (e.g., 0.7) may be 0.5. For the water spraying which has the third priority, the difference between the first recognition value (e.g., 0.1) and the second recognition value (e.g., 0.5) may be 0.4. For the air spraying which has the fourth priority, the difference between the first recognition value (e.g., 0.3) and the second recognition value (e.g., 0.6) may be 0.3. For the warning message transmission which has the fifth and last priority, the difference between the first recognition value (e.g., 0.1) and the second recognition value (e.g., 0.7) may be 0.6.

The difference between the first recognition value and the second recognition value being large means that the probability for the pedestrian to recognize the vehicle 100 has increased. Thus, the larger the difference between the first recognition value and the second recognition value is, the higher the effect of the warning signal may be predicted to be.

The processor 110 may update the priority of each warning signal so that the priority increases as the difference for each warning signal increases. Thus, the warning sound which shows the largest difference, e.g., 0.7, may be updated to remain the first priority, the warning message transmission which shows the next largest difference, e.g., 0.6, may be updated to have the second priority, and the warning light which shows the third largest difference, e.g., 0.5, may be updated to have the third priority.

The water spraying which shows the fourth largest difference, e.g., 0.4, may be updated to have the fourth priority, and the air spraying which shows the smallest difference, e.g., 0.3, may be updated to have the fifth priority.

The above-described updating operation may be performed based on the difference between the first recognition value and the second recognition value or, when the warning signal is output a predetermined number of times or more, the updating operation may be performed based on the mean difference between the first recognition value and the second recognition value.

As described above, the present invention may determine the efficiency of warning signals and accordingly update the priorities of the warning signals, advantageously alerting the pedestrian of danger in the most efficient way.

In the above-described examples, each step of FIG. 1 is performed by the processor 110 in the vehicle 100. However, without limitations, the steps may be performed by a processor in the server 200 and, to that end, the vehicle 100 and the server 200 may perform data communication.

For illustration purposes, it is described below that the vehicle 100 transmits information detected by the sensor module 130 (the information is referred to hereinafter as sensing information) and that the server 200 determines the necessity of control on the vehicle 100 based on the sensing information and, if control is needed, the server 200 transmits remote control signals to the vehicle 100.

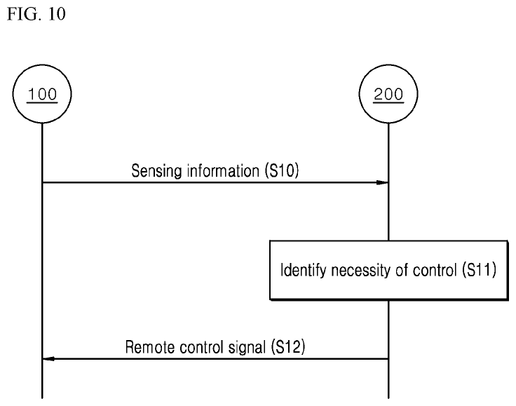

FIG. 10 is a view briefly illustrating a data communication process between a server and a vehicle as shown in FIG. 2.

Referring to FIG. 10, the driving vehicle may transmit sensing information detected by the sensor module 130 to a server (S10), and the server may identify the necessity of control on the vehicle by calculating a recognition value based on the sensing information (S11) and may then transmit a remote control signal to the vehicle (S12). The vehicle may be thus controlled based on the information detected by the sensor module 130.

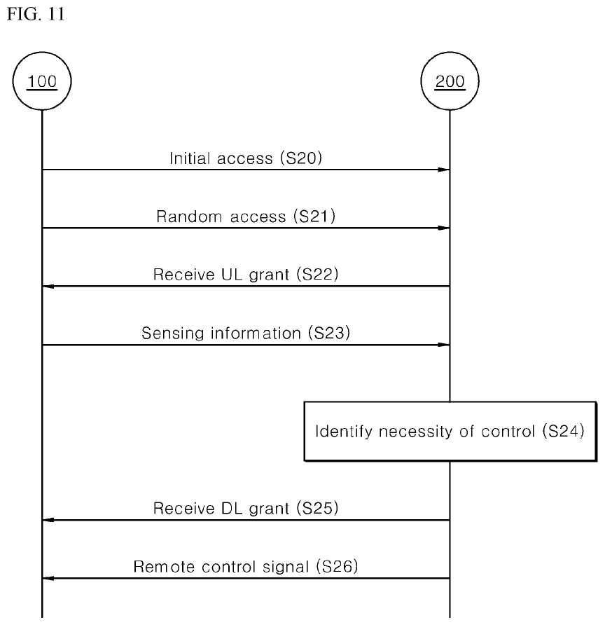

For the operations, the vehicle and the server may perform data communication via any wireless communication scheme available in the art. In particular, the vehicle and the server may perform data communication over a 5^{th} generation (5G) network. Described below in detail is a data communication method via a 5G network with reference to FIGS. 11 to 15.

FIG. 11 is a view illustrating an example process of application communication between a vehicle and a server in a 5G communication system.

The vehicle 100 may perform an initial access procedure with the server 200 (S20).

The initial access procedure may include a cell search for obtaining a downlink (DL) operation and a process of obtaining system information.

The vehicle 100 may perform a random access procedure with the server 200 (S21).

The random access procedure may include uplink (UL) synchronization, transmission of a preamble for UL data transmission, and a random access response reception process.

The server 200 may transmit a UL grant for scheduling the transmission of sensing information to the vehicle 100 (S22).

UL grant reception may include the process of receiving a time/frequency schedule for transmission of UL data to the server 200.

The vehicle 100 may transmit the sensing information to the server 200 based on the UL grant (S23).

The server 200 may perform the operation of identifying the necessity of control for transmitting a remote control signal based on the sensing information (S24).

The vehicle 100 may receive a DL grant via a physical downlink control channel to receive the remote control signal from the server 200 (S25).

The server 200 may transmit a remote control signal to the vehicle 100 based on the DL grant (S26).

Although an example combination of the initial access procedure and/or random access procedure between the vehicle 100 and 5G communication and the procedure of receiving a downlink grant has been described via steps S20 to S26 in connection with an example thereof, the present invention is not limited thereto.

For example, the initial access procedure and/or random access procedure may be performed via steps S20, S22, S23, S24, and S25. As another example, the initial access procedure and/or random access procedure may be performed via steps S21, S22, S23, S24, and S26.

The operations of the vehicle 100 have been described above in connection with steps S20 to S26 as an example, but the present invention is not limited thereto.

For example, the operations of the vehicle 100 may be performed, with steps S20, S21, S22, and S25 selectively combined with steps S23 and S26 As another example, the operations of the vehicle 100 may consist of steps S21, S22, S23, and S26. As another example, the operations of the vehicle 100 may consist of steps S20, S21, S23, and S26. As another example, the operations of the vehicle 100 may consist of steps S22, S23, S25, and S26.

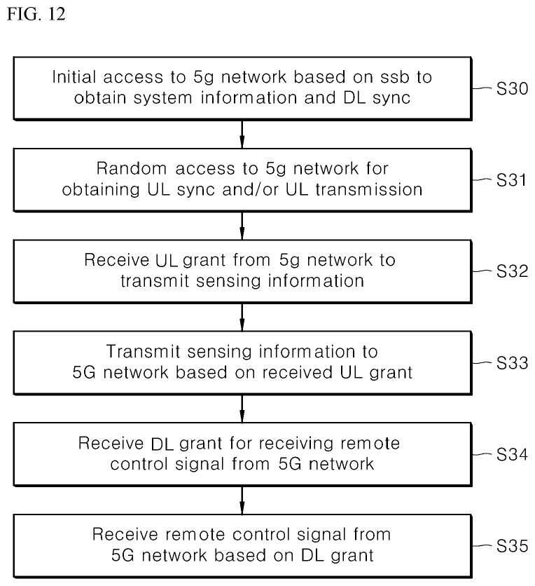

FIGS. 12, 13, 14, and 15 are views illustrating example operations of a vehicle using 5G communication.

Referring to FIG. 12, the vehicle 100 may perform an initial access procedure with the server 200 based on a synchronization signal block (SSB) to obtain system information and DL synchronization (S30).

The vehicle 100 may perform a random access procedure with the server 200 for UL synchronization and/or UL transmission (S31).

The vehicle 100 may receive a UL grant from the server 200 to transmit the sensing information (S32).

The vehicle 100 may transmit the sensing information to the server 200 based on the UL grant (S33).

The vehicle 100 may receive a DL grant for receiving a remote control signal from the server 200 (S34).

The vehicle 100 may receive a remote control signal from the server 200 based on the DL grant (S35).

Step S30 may add a beam management (BM) process, step S31 may add a beam failure recovery process related to physical random access channel (PRACH) transmission, step S32 may add a QCL relation in relation to the beam reception direction of PDCCH containing a UL grant, and step S33 may add a QCL relation in relation to the beam transmission direction of physical uplink control channel (PUCCH)/physical uplink shared channel (PUSCH) containing the departure location/destination location. Step S34 may add a QCL relation in connection with the direction of PDCCH beam reception.

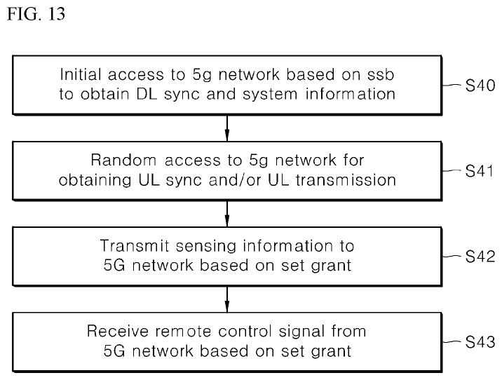

Referring to FIG. 13, the vehicle 100 may perform an initial access procedure with the server 200 based on an SSB to obtain system information and DL synchronization (S40).

The vehicle 100 may perform a random access procedure with the server 200 for UL synchronization and/or UL transmission (S41).

The vehicle 100 may transmit the sensing information to the server 200 based on a configured grant (S42). In other words, instead of receiving the UL grant from the server 200, the sensing information may be transmitted to the server 200 based on the configured grant.

The vehicle 100 may receive a remote control signal from the server 200 based on the configured grant (S43).

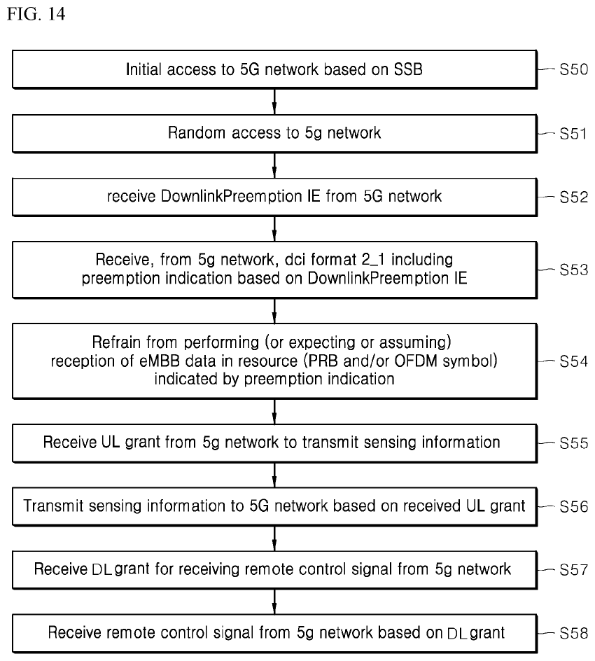

Referring to FIG. 14, the vehicle 100 may perform an initial access procedure with the server 200 based on an SSB to obtain system information and DL synchronization (S50).

The vehicle 100 may perform a random access procedure with the server 200 for UL synchronization and/or UL transmission (S51).

The vehicle 100 may receive a DownlinkPreemption IE from the server 200 (S52).

The vehicle 100 may receive a DCI format 2_1 containing a preemption indication from the server 200 based on the DownlinkPreemption IE (S53).

The vehicle 100 may refrain from receiving (or expecting or assuming the reception of) eMBB data in the resource (PRB and/or OFDM symbols) indicated by the preemption indication (S54).

The vehicle 100 may receive a UL grant from the server 200 to transmit the sensing information (S55).

The vehicle 100 may transmit the sensing information to the server 200 based on the UL grant (S56).

The vehicle 100 may receive a DL grant for receiving a remote control signal from the server 200 (S57).

The vehicle 100 may receive a remote control signal from the server 200 based on the DL grant (S58).

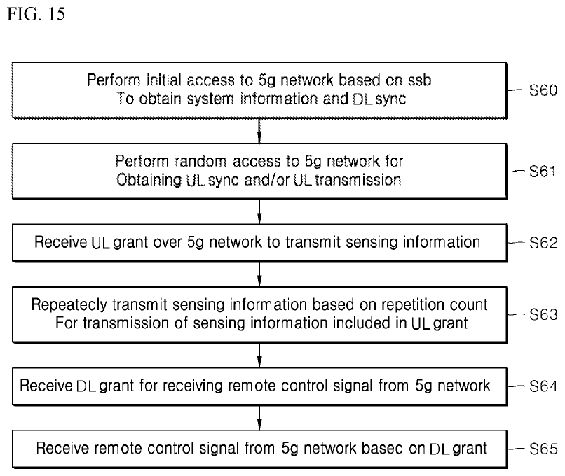

Referring to FIG. 15, the vehicle 100 may perform an initial access procedure with the server 200 based on an SSB to obtain system information and DL synchronization (S60).

The vehicle 100 may perform a random access procedure with the server 200 for UL synchronization and/or UL transmission (S61).

The vehicle 100 may receive a UL grant from the server 200 to transmit the sensing information (S62).

The UL grant may contain information about the number of times of repetition for transmission of the sensing information, and the sensing information may be repeatedly transmitted based on the number-of-times-of-repetition information (S63).

The vehicle 100 may transmit the sensing information to the server 200 based on the UL grant.

Repeated transmission of the sensing information may be carried out via frequency hopping, and first sensing information may be transmitted in a first frequency resource, and second sensing information may be transmitted in a second frequency resource.

The sensing information may be transmitted via a narrow band of 1 RB (resource block) or 6 RB.

The vehicle 100 may receive a DL grant for receiving a remote control signal from the server 200 (S64).

The vehicle 100 may receive a remote control signal from the server 200 based on the DL grant (S65).

Although data communication between the vehicle 100 and the server 200 has been described in connection with an example thereof based on transmission/reception of remote control signals and sensing information with reference to FIGS. 11 to 15, the above-described communication method may be applicable to any signals transmitted or received between the server 200 and the vehicle 100.

The 5G communication technology described above may be added to embody or clarify data communication methods performed by the vehicle 100 according to the disclosure. However, the data communication method by the vehicle 100 is not limited thereto, and the vehicle 100 may perform data communication by other various methods available in the technical field.

While the present invention has been shown and described with reference to exemplary embodiments thereof, it will be apparent to those of ordinary skill in the art that various changes in form and detail may be made thereto without departing from the spirit and scope of the present invention as defined by the following claims. Further, although operations and effects according to the configuration of the present invention are not explicitly described in the foregoing detailed description of embodiments, it is apparent that any effects predictable by the configuration also belong to the scope of the present invention.

What is claimed is:

1. A method of controlling a vehicle, the method comprising:
identifying a pedestrian within a vicinity of the vehicle;
determining a first recognition value of the pedestrian for the vehicle based on a first behavior feature of the pedestrian, wherein the first recognition value is associated with a likelihood that the pedestrian recognizes the vehicle;
outputting a warning signal based on the determined first recognition value;
determining a second recognition value of the pedestrian for the vehicle after outputting the warning signal based on a second behavior feature of the pedestrian, wherein the second recognition value is associated with a likelihood that the pedestrian recognizes the outputted warning signal; and
controlling the vehicle based on the determined second recognition value.

2. The method of claim 1, wherein the pedestrian is identified based on the pedestrian being positioned within a reference space defined as a space in front of the vehicle.

3. The method of claim 2, wherein the pedestrian is identified based on identifying the pedestrian positioned closest to the vehicle from among a plurality of pedestrians also identified as positioned within the reference space.

4. The method of claim 1, wherein identifying the pedestrian further includes:
generating a virtual lane based on a width of the vehicle; and
identifying that the pedestrian is positioned within a reference space of the virtual lane, wherein the reference space is defined as a space in front of the vehicle.

5. The method of claim 1, wherein the first or second behavior feature of the pedestrian corresponds to a walking direction of the pedestrian.

6. The method of claim 5, wherein determining the first recognition value of the pedestrian for the vehicle based on the walking direction of the pedestrian further includes:
determining that the first recognition value is higher than a reference value when the walking direction of the pedestrian is in an opposite direction to a driving direction of the vehicle; and
determining that the first recognition value is lower than the reference value when the walking direction of the pedestrian is in a same direction as the driving direction of the vehicle.

7. The method of claim 5, wherein the first recognition value is determined in proportion to an angle between the walking direction of the pedestrian and a driving direction of the vehicle.

8. The method of claim 1, wherein the first recognition value is determined based on a viewing direction of the pedestrian while walking.

9. The method of claim 8, wherein the first recognition value is determined based on whether an obstacle is located in the viewing direction of the pedestrian while walking, wherein the obstacle is positioned between the pedestrian and the vehicle.

10. A machine-readable non-transitory medium having stored thereon machine-executable instructions for:
identifying a pedestrian within a vicinity of a vehicle;
determining a first recognition value of the pedestrian for the vehicle based on a first behavior feature of the pedestrian, wherein the first recognition value is associated with a likelihood that the pedestrian recognizes the vehicle;
outputting a warning signal based on the determined first recognition value;
determining a second recognition value of the pedestrian for the vehicle after outputting the warning signal based on a second behavior feature of the pedestrian, wherein the second recognition value is associated with a likelihood that the pedestrian recognizes the outputted warning signal; and
controlling the vehicle based on the determined second recognition value.

11. The method of claim 1, wherein the first or second behavior feature of the pedestrian is based on identifying a walking pattern of the pedestrian, wherein the first or second recognition value is determined in proportion to a degree of regularity of the identified walking pattern.

12. The method of claim 1, wherein the warning signal is outputted when the determined first recognition value is lower than a warning reference value.

13. The method of claim 1, wherein the warning signal corresponds to outputting a warning light or a warning sound based on the first behavior feature of the pedestrian, transmitting the warning signal to a terminal of the pedestrian, or spraying air or water.

14. The method of claim 1, wherein the warning signal corresponds to outputting a warning light when a walking direction of the pedestrian is opposite to a driving direction of the vehicle, and outputting a warning sound when the walking direction of the pedestrian is in a same direction as the driving direction of the vehicle.

15. The method of claim 1, wherein the warning signal corresponds to spraying air or water when a degree of regularity of a walking pattern of the pedestrian is lower than a reference value.

16. The method of claim 1, wherein the warning signal is outputted based on the first behavior feature of the pedestrian associated with a lowest determined first recognition value compared to a plurality of pedestrians identified as adjacent to the vehicle when the plurality of pedestrians are each associated with respective first recognition value determined to be lower than a warning reference value.

17. The method of claim 1, wherein outputting the warning signal further includes outputting a single warning signal according to an ordering of preset priority values, wherein each warning signal is associated with a preset priority value.

18. The method of claim 17, further comprising updating the preset priority of each warning signal so that a priority for the warning signal increases as a difference between the first determined recognition value and the second determined recognition value increases.

19. The method of claim 1, wherein controlling the vehicle further includes controlling the vehicle when the second determined recognition value is lower than a preset reference value.

20. The method of claim 1, wherein controlling the vehicle further includes controlling a speed of the vehicle in proportion to the second determined recognition value.
